(19) United States
(12) Patent Application Publication
(10) Pub. No.: US 2019/0150602 A1
(43) Pub. Date: May 23, 2019

(54) Tool for Removing Particles

(71) Applicant: Lilly Brush Company, LLC, Englewood, CO (US)

(72) Inventor: Elsie Cryder Hamilton, Englewood, CO (US)

(21) Appl. No.: 15/816,136

(22) Filed: Nov. 17, 2017

(51) Int. Cl. A46B 15/00; B08B 1/00; A46B 9/02

(52) U.S. Cl. CPC A46B 15/0081; B08B 1/002; A46B 2200/3046; A46B 9/02; A46B 2200/3033; B08B 1/005

(57) ABSTRACT

A method of removing unwanted particles from a target surface includes gripping a brush. The brush has a handle, a head, a plurality of bristles, and a blade. The head has a first surface and a second surface, one of the first and second surfaces being a top surface and the other of the first and second surfaces being a bottom surface. Each of the plurality of bristles has an attached end attached to the second surface of the head. The blade is attached to the head and extends from the head. The method further includes orienting the brush such that the first surface is oriented towards the target surface and moving the handle such that the blade is dragged along the target surface. The method further includes removing from the target surface the unwanted particles adhered to the blade.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND

### Field

This disclosure relates generally to a tool for removing unwanted particles from a surface and, more particularly, to a tool having a blade and a plurality of bristles.

### SUMMARY

One aspect of the disclosure relates to a method of removing unwanted particles from a target surface including gripping a brush. The brush has a handle, a head, a plurality of bristles, and a blade. The head has a first surface and a second surface, one of the first and second surfaces being a top surface and the other of the first and second surfaces being a bottom surface. Each of the plurality of bristles has an attached end and a free end. The attached end of each of the plurality of bristles is attached to the second surface of the head and the free end of each of the plurality of bristles is spaced from the second surface. The free ends of the plurality of bristles collectively form a bristle surface. The blade is attached to the head and extends from the head. The blade has a fixed end attached to the head and a trailing edge end opposite the fixed end. The blade is flexible and adapted and configured to adhere the unwanted particles to the blade. The handle is attached to the head. The method further includes orienting the brush such that the first surface is oriented towards the target surface and moving the handle such that the blade is dragged along the target surface in a first direction and at least some of the unwanted particles are adhered to the blade, as the blade is dragged in the first direction the trailing edge end trails the head. The method further includes removing from the target surface the unwanted particles adhered to the blade.

Another aspect of the disclosure relates

### BRIEF DESCRIPTION OF THE DRAWINGS

The accompanying drawings, which are incorporated in and form a part of the specification, illustrate the embodiments of the present disclosure and together with the description, serve to explain the principles of the disclosure. In the drawings:

FIG. 1 is a perspective view of a tool for removing particles from a surface.

FIG. 2 is a further perspective view of the tool shown in FIG. 1.

FIG. 3 is a top view of the tool shown in FIG. 1.

FIG. 4 is a bottom view of the tool shown in FIG. 1.

FIG. 5 is a left elevation view of the tool shown in FIG. 1.

FIG. 6 is a right elevation view of the tool shown in FIG. 1.

FIG. 7 is a rear elevation view of the tool shown in FIG. 1.

FIG. 8 is a front elevation view of the tool shown in FIG. 1.

FIG. 9A is a side view of the tool shown in FIG. 1 with the tool in a first orientation being moved relative to a surface.

FIG. 9B is a side view of the tool shown in FIG. 1 with the tool in a second orientation being moved relative to a surface.

FIG. 10 a perspective view of the blade of the tool shown in FIG. 1.

FIG. 11 is top view of the blade shown in FIG. 10.

FIG. 12 is a side view of the blade shown in FIG. 10.

### DETAILED DESCRIPTION

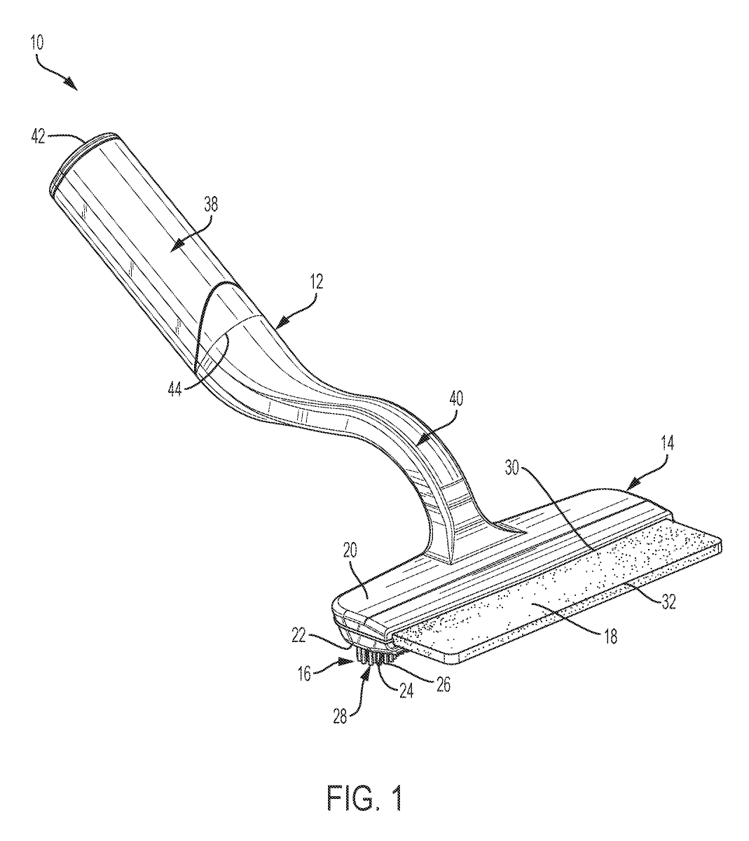

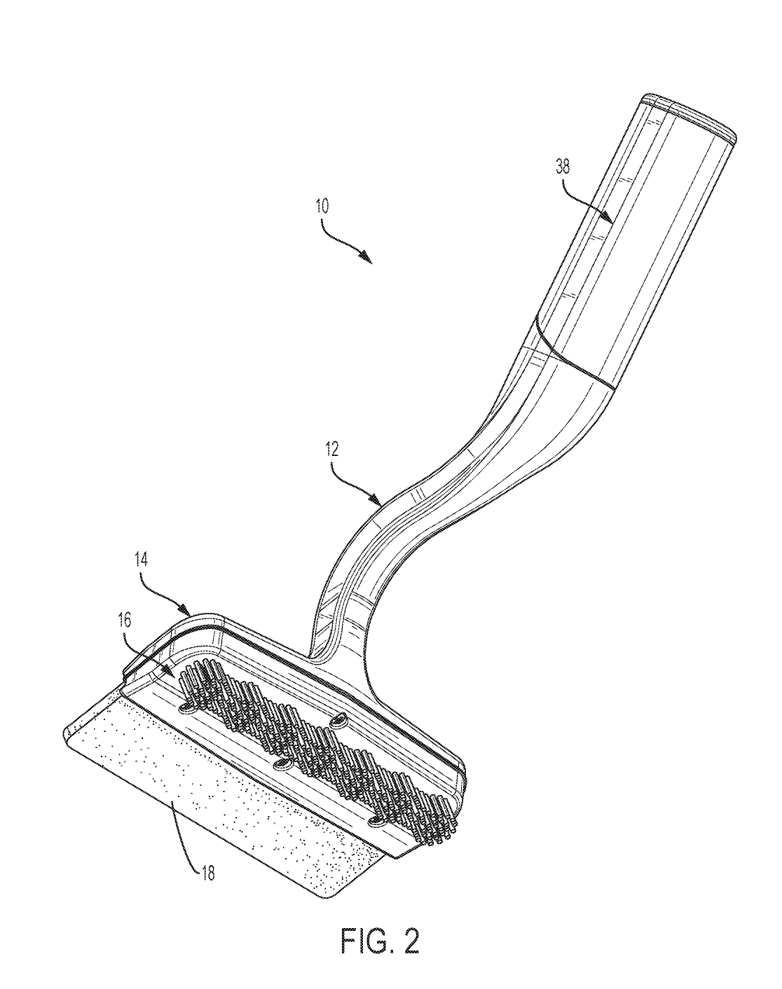

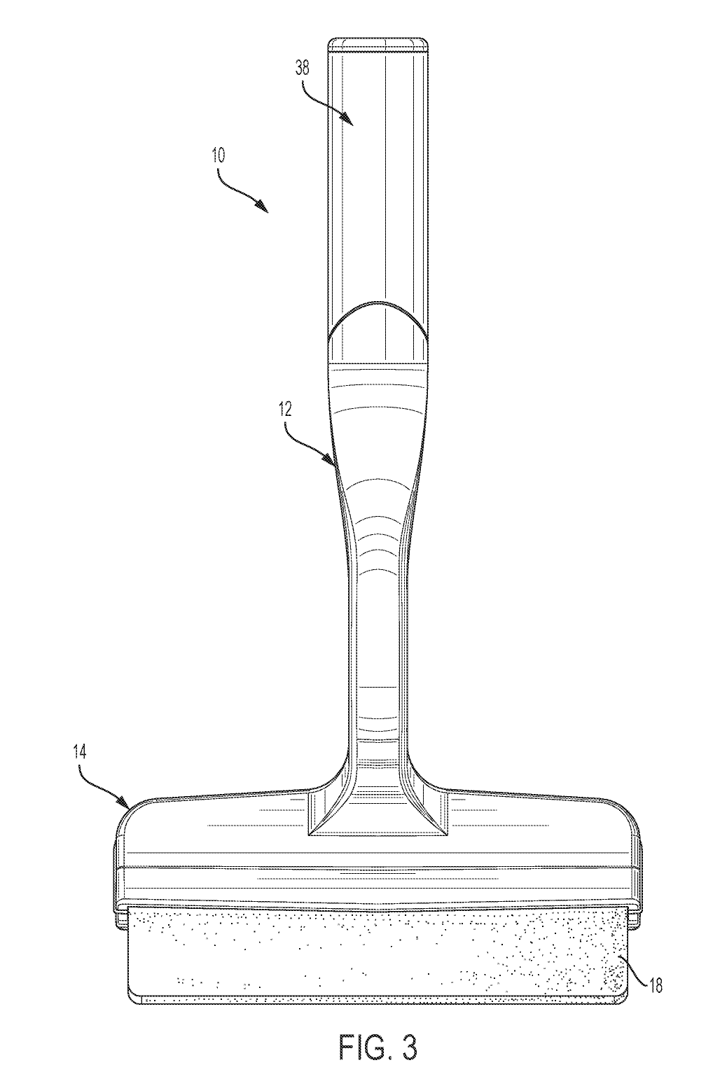

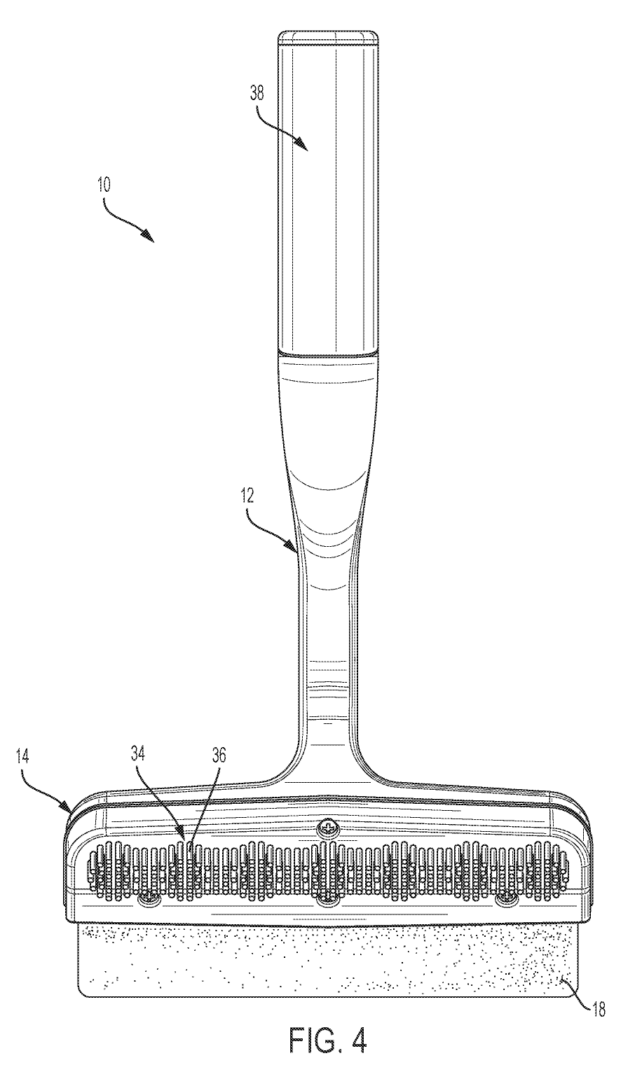

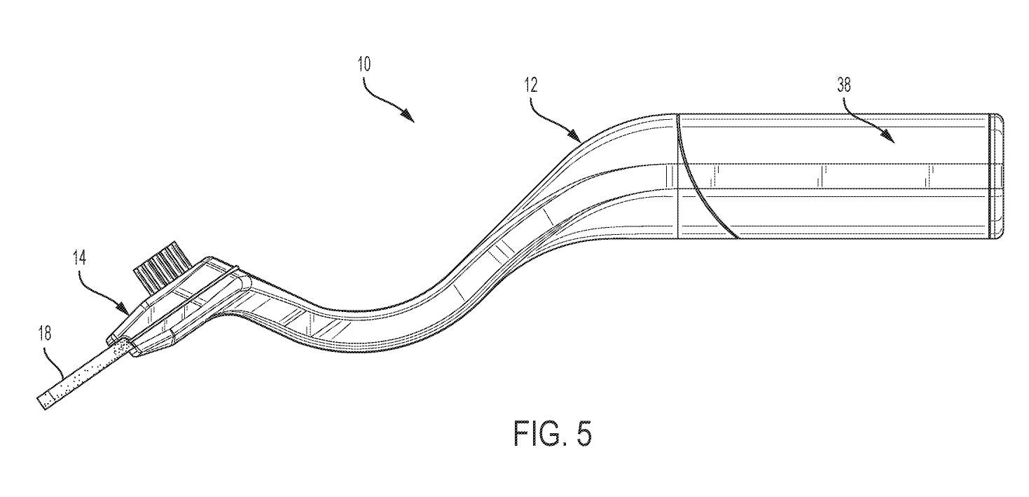

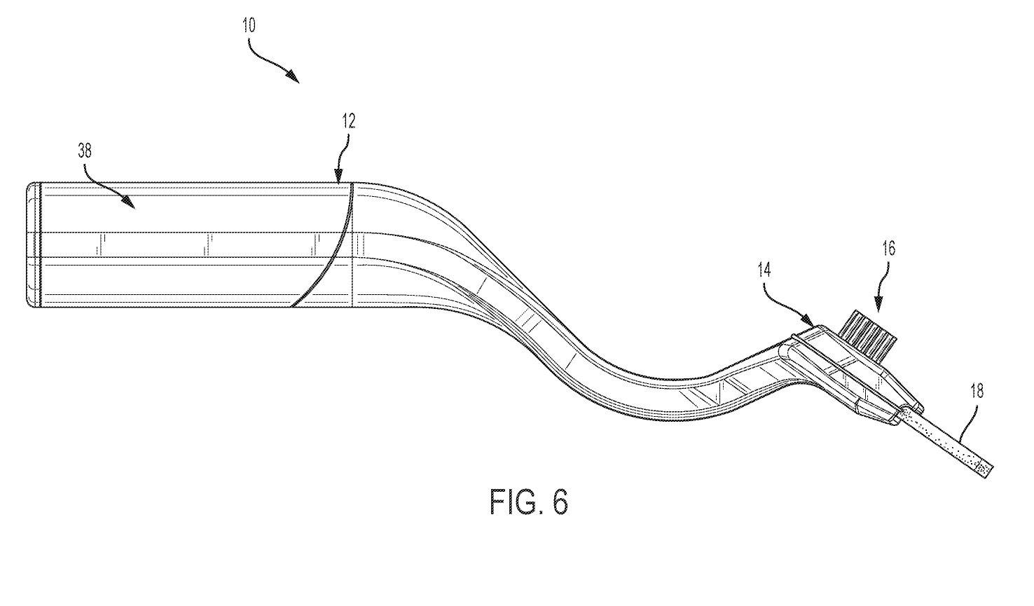

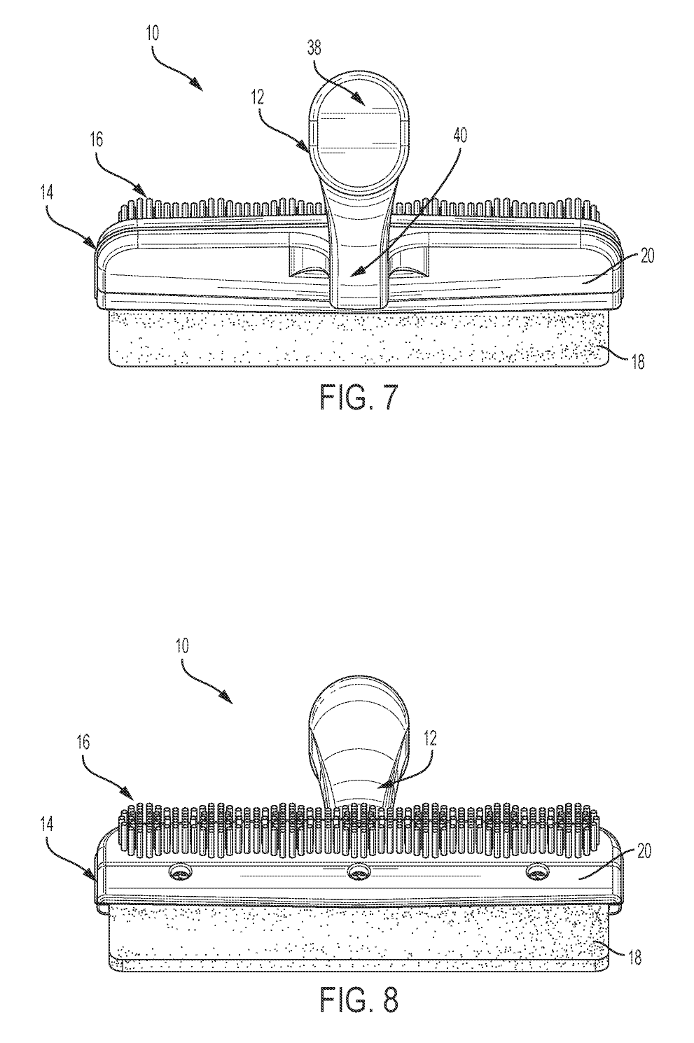

FIGS. 1 through 12 depict an embodiment of a brush type tool 10 for removing particles from a surface. The brush 10 having a handle 12, a head 14, a plurality of bristles 16, and a blade 18. The handle 12 is attached to the head 14. The head 14 has a first surface 20 and a second surface 22. One of the first and second surfaces 20,22 is a top surface and the other of the first and second surfaces 20,22 is a bottom surface. For example, and without limitation, the first surface 20 is the top surface and the second surface 22 is the bottom surface. Each of the plurality of bristles 16 has an attached end 24 and a free end 26. The attached end 24 of each of the plurality of bristles 16 is attached to the second surface 22 of the head 20. The free end 26 of each of the plurality of bristles 16 is spaced from the second surface 22. The free ends 26 of the plurality of bristles 16 collectively form a bristle surface 28. The blade 18 is attached to the head 14 and extends from the head 14 (e.g., in a first direction away from the head and substantially parallel with one or more of the first and second surface 20,22). The blade 18 has a fixed end 30 attached to the head 14 and a trailing edge end 32 opposite the fixed end 30. The blade 18 is flexible and adapted and configured to adhere the unwanted particles to the blade 18.

In some embodiments, the plurality of bristles 16 includes one or more sub-assemblies 34 of bristle tufts including at least a first bristle tuft 36. The first bristle tuft 36 includes tightly packed tuft ends with densely arranged bristles formed from a material with a relatively high elastic modulus. In some embodiments, the plurality of bristles 16 includes a second bristle tuft. The second bristle tuft includes relatively less densely arranged bristles than the first bristle tuft. In some embodiments, the second bristle tufts included bristles that are longer than those of the first bristle tuft. The second bristle tuft may collect and hold particles against the first bristle tuft (e.g., as the plurality of bristles are dragged against a surface). The second bristle tufts may be interspersed with the first bristle tuft throughout the plurality of bristles 16.

In some embodiments, the bristle tufts 36 are arranged in rows of varying numbers of bristle tufts 36. For example, and without limitation, individual sub-assemblies 34 of bristle tufts 36 may be arranged in rows of three, four, five, and six tufts. In alternative embodiments, the bristle tufts are arranged in other number of rows. The varying number of rows of tufts 36 results in an overall non-linear or sinuous shape of the sub-assemblies 34.

The handle 12 includes a grip portion 38 and a neck portion 40. The grip portion extends along an axis from a first end 42 to a second end 44. The neck portion 40 extends from the second end 44 of the grip portion 38. The neck portion 40 is connected to the first elongated surface 20 of the head 14 such that the first and second elongated surface 20,22 are positioned at an included angle relative to the axis of the grip portion 38. The included angle is preferably less than ninety degrees. The included angle is more preferably between forty and fifty degrees, inclusive.

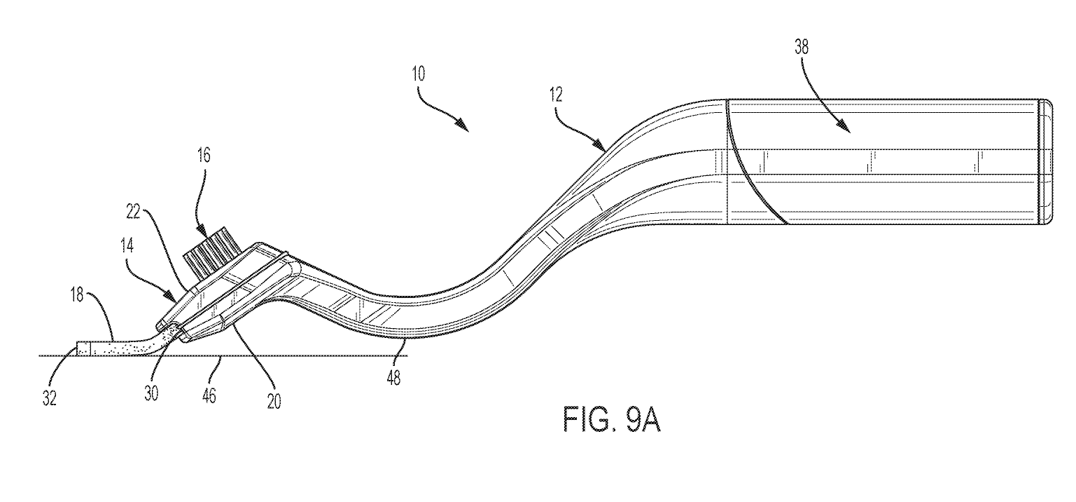

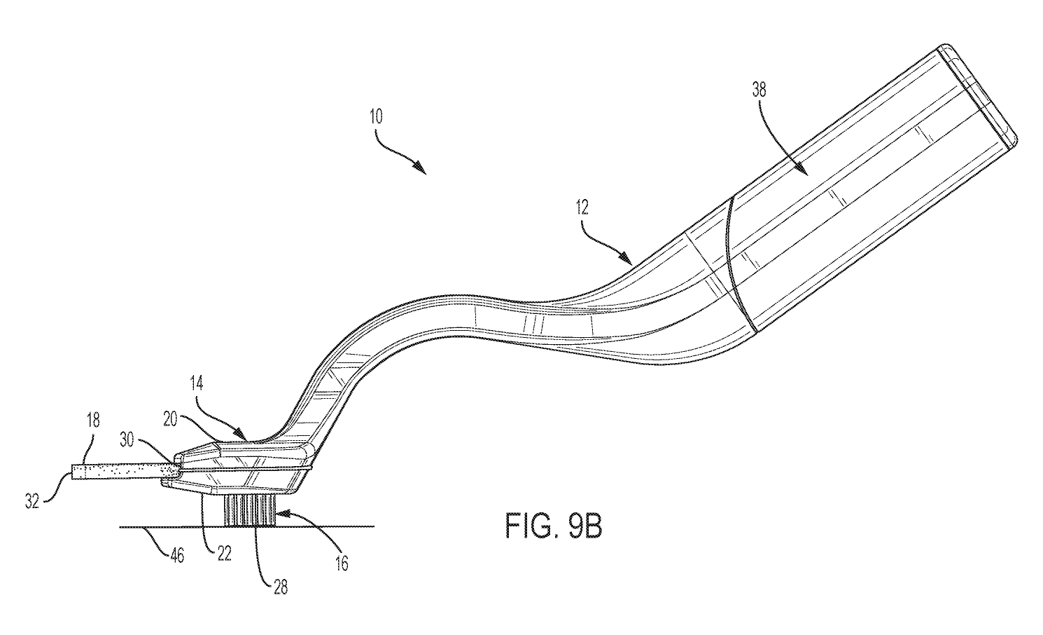

The first and second elongated surfaces 20,22 are angled relative to the grip portion 38 of the handle 12 such that when the handle 12 is gripped to orient the first elongated surface towards a target surface 46, the first elongated surface 20 is angled with respect to the target surface 46 to facilitate deflection of the blade 18 such that a substantial portion of the blade 18 is in contact with the target surface 46 (this configuration is depicted in FIG. 9). The first and second elongated surfaces 20,22 are also angled relative to the grip portion 38 of the handle 12 such that when the handle is gripped to orient the second elongated surface 22 towards the target surface 46, the second elongated surface 22 is angled with respect to the target surface 46 to facilitate removal of the unwanted particles from the target surface 46 by aligning the plurality of bristles 16 substantially perpendicular to the target surface 46.

The neck portion 40 is shaped to provide this alignment of the first and second elongated surfaces 20,22. In some embodiments, the neck portion 40 is curvilinear (as depicted). The neck portion 40 is curvilinear such that when the grip portion 38 is substantially parallel with the target surface 46 and the first elongated surface 20 of the head 14 is oriented towards the target surface, an apex 48 of the neck portion is positioned closer to the surface than the grip portion 38.

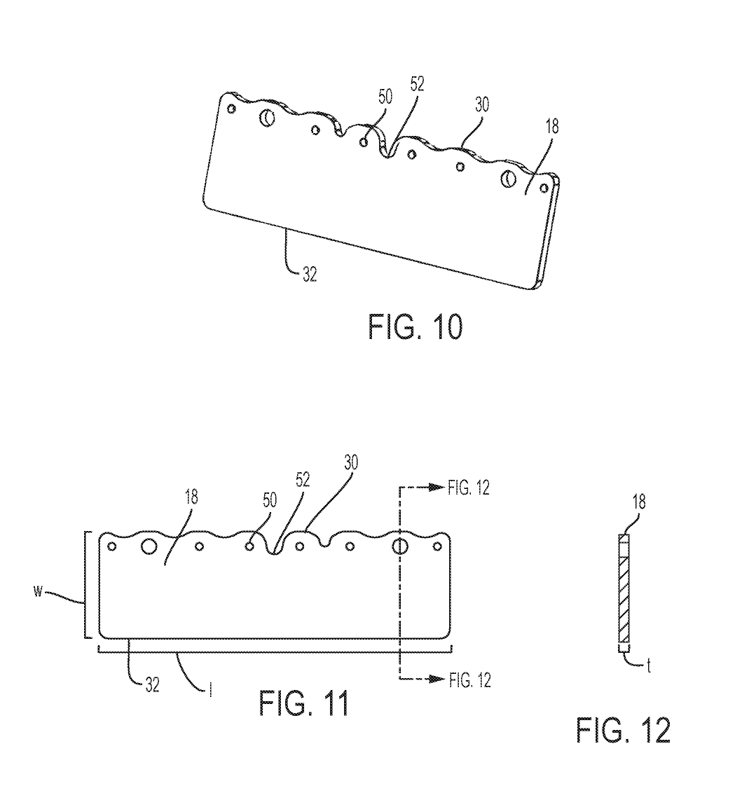

Referring now to FIGS. 10 through 12, the blade 18 is adapted and configured to adhere particle to itself. In some embodiments, the blade 18 is constructed of polyurethane. For example, 13. The polyurethane preferably has a Shore hardness of between 46 and 54 on the Shore A durometer scale and more particularly has a Shore hardness of 52 on the Shore A durometer scale. Such a hardness provides sufficient adherence to attach unwanted particles and maintain the integrity of the blade 18 (e.g., prevent tearing during use). In some embodiments, the polyurethane is between 80 and 90 percent polyester resin, between 0.5 and 2 percent trim ethylolpropane, between 0.5 and 2.5 percent butanediol, between 1.5 and 3.5 percent 4,4′-Methylenebis(2-chloroaniline), and between 8 and 10 percent dioctyl phthalate. More preferably, the polyurethane is approximately 85 percent polyester resin, approximately 1.25 percent trimethylolpropane, approximately 1.5 percent butanediol, approximately 2.5 percent 4,4′-Methylenebis(2-chloroaniline), and approximately 9 percent dioctyl phthalate. In alternative embodiments, the blade 18 has a different composition, polyurethane or otherwise.

In some embodiments, the blade 18 has a thickness t of between two millimeters and four millimeters, inclusive. More preferably the blade 18 has a thickness of between 3.2 millimeters and 3.6 millimeters, inclusive (e.g., 3.4 millimeters). In alternative embodiments, the blade 18 has any other thickness suitable to allow the blade 18 to flex as described herein. The blade 18 has a length/of between 100 and 140 millimeters, inclusive. More preferably, the blade 18 was a length/of approximately 120 millimeters. The blade 18 has a width w of between 32 and 40 millimeters, inclusive. More preferably, the blade 18 has a width w of approximately 36 millimeters. In an alternative embodiment, the blade 18 has a width w of between 21 and 29 millimeters, inclusive. More preferably, the blade 18 has a width w of approximately 25 millimeters. A blade with a shorter width w may reduce the likelihood that the blade tears or is otherwise damaged.

In some embodiments, the blade 18 includes one or more through holes 50 for coupling the blade 18 to the head 14. The blade 18 also includes one or more troughs 52 in the fixed end 30 that may facilitate coupling the blade 18 to the head 14. For example, one or more of the first and second elongated surfaces 20,22 include posts in the interior of the head 14 running between the first and second elongated surfaces 20,22. Some of these posts extend through the through holes 50 and some of these posts engage with the troughs 52 such that the blade 18 is secured to the head 14.

In some embodiments, the head 14 of the brush 10 is of two part construction. The two parts being releasably secured to each other by one or more fasteners (e.g., screws or the like). The brush 10 may be supplied to a user with two blades 18 of different dimensions (e.g., different widths w) such that the user can replace blades of different dimensions in the brush 10. For example, and without limitation, a user may detach one of the two parts of the head 14 by unscrewing screws securing the two parts to each other. A blade 18 may be removed by sliding the bade off of one more posts around which the through holes 50 of the blade 18 are position. A replacement blade or blade of different dimensions may be placed into the head 14 with through holes 50 being positioned around the one or more posts. The second part of the head is then attached to the first part and the screws are tightened to secure the two portions of the head 14 to one another with the blade 18 secured therebetween.

In operation, a user grips the handle 38 of the brush 10. The user orients the brush 10 such that the first surface 20 is oriented towards the target surface 46 (e.g., the first surface 20 is closer to the target surface 46 than the second surface 22 such that the plurality of bristles point generally away from the target surface). The user moves the handle 38 such that the blade 18 is dragged along the target surface 46 in a first direction. The first direction is generally parallel to the target surface 46 and runs from the trailing edge end 32 of the blade towards the fixed end 30. As the blade 18 is dragged in the first direction, the trailing edge end 32 trails the head 14. The first direction as used herein may include any direction in which the blade 18 is dragged along the target surface 46 such that unwanted particles on the target surface 46 are adhered to the blade 18. As the user moves the brush 10 at least some of the unwanted particles are adhered to the blade 18. As the blade 18 is dragged along the target surface 46, the blade 18 deflects. This results from the flexible construction of the blade 18. Because the blade 18 deflects, a substantial portion of the blade 18 is in contact with the target surface 46. This provides a greater surface area of the blade 18 to which unwanted particles can adhere. A substantial portion of the blade 18 may be at least 10 percent, 20 percent, 30 percent, at least half, or more of the blade 18.

At least some of the unwanted particles are removed from the target surface 46. Removing unwanted particle from the target surface 46 may include removing the blade 18 from the target surface 46 such that the unwanted particles adhered to the blade 18 are removed from the target surface 46 while adhered to the blade 18. A user may rinse the blade with a liquid to remove the unwanted particles from the blade 18.

A user may further orient the second elongated surface 22 towards the target surface 46 to use the plurality of bristles 16 to remove unwanted particles from the target surface 46. The user moves the handle 38 such that the bristle surface 28 is moved along the target surface 46 in one or more of the first direction (e.g., from the trailing edge end 32 of the blade 18 towards the fixed end 30) and a second direction opposite the first direction such that at least some of the unwanted particles are removed from the target surface 46.

In some embodiments, the target surface 46 includes one or more of a knitted natural fiber, a fleece, a clothing fabric, a carpet, an upholstery material, a vehicle interior, or the like. In some embodiments, the unwanted particles includes at least one or more of fabric pills, hair, dander, lint, plant material, animal fur, or the like.

In view of the foregoing, it will be seen that several advantages are achieved and attained.

The embodiments were chosen and described in order to best explain the principles of the disclosure and its practical application to thereby enable others skilled in the art to best utilize the disclosure in various embodiments and with various modifications as are suited to the particular use contemplated.

As various modifications could be made in the constructions and methods herein described and illustrated without departing from the scope of the disclosure, it is intended that all matter contained in the foregoing description or shown in the accompanying drawings shall be interpreted as illustrative rather than limiting. For example. Thus, the breadth and scope of the present disclosure should not be limited by any of the above-described exemplary embodiments, but should be defined only in accordance with the following claims appended hereto and their equivalents.

What is claimed is:

1. A method of removing unwanted particles from a target surface, the method comprising:
gripping a brush, the brush having a handle, a head, a plurality of bristles, and a blade, the head having a first surface and a second surface, one of the first and second surfaces being a top surface and the other of the first and second surfaces being a bottom surface, each of the plurality of bristles having an attached end and a free end, the attached end of each of the plurality of bristles being attached to the second surface of the head and the free end of each of the plurality of bristles being spaced from the second surface, the free ends of the plurality of bristles collectively forming a bristle surface, the blade being attached to the head and extending from the head, the blade having a fixed end attached to the head and a trailing edge end opposite the fixed end, the blade being flexible and adapted and configured to adhere the unwanted particles to the blade, the handle being attached to the head;
orienting the brush such that the first surface is oriented towards the target surface;
moving the brush to drag the blade along the target surface in a first direction so that at least some of the unwanted particles adhere to the blade, the trailing edge trailing the head as the blade is moved in the first direction.

2. A method in accordance with claim 1, wherein as the blade is dragged along the target surface, the blade deflects sufficiently such that at least half of the blade is in contact with the target surface.

3. A method in accordance with claim 1 further comprising removing the blade from the target surface such that the at least some unwanted particles are removed from the surface while adhered to the blade.

4. A method in accordance with claim 3 further comprising rinsing the blade with a liquid to remove the unwanted particles from the blade.

5. A method in accordance with claim 1 further comprising:
orienting the second elongated surface towards the target surface; and
moving the brush such that the bristle surface is moved along the target surface in one or more of the first direction and a second direction such that at least some of the unwanted particles are removed from the target surface, the second direction being opposite the first direction.

6. A method in accordance with claim 5, wherein the plurality of bristles includes one or more sub-assemblies of bristle tufts including a first bristle tuft, wherein the first bristle tuft includes tightly packed tuft ends with densely arranged bristles formed from a material with a relatively high elastic modulus.

7. A method in accordance with claim 6, wherein the bristle tufts are arranged in rows of varying numbers of bristle tufts.

8. A method in accordance with claim 1, wherein the handle includes a grip portion and a neck portion, the grip portion extending along an axis from a first end to a second end, the neck portion extending from the second end of the grip portion and being connected to the first elongated surface of the head such that the first and second elongated surfaces are positioned at an included angle relative to the axis of the grip portion, the included angle being less than ninety degrees.

9. A method in accordance with claim 8, wherein the included angle is between forty and fifty degrees.

10. A method in accordance with claim 1, wherein the handle includes a grip portion and a neck portion, the grip portion extending along an axis from a first end to a second end, the neck portion extending from the second end of the grip portion and being connected to the first elongated surface of the head, wherein the first and second elongated surfaces are angled relative to the grip portion of the handle such that when the handle is gripped to orient the first elongated surface towards the target surface the first elongated surface is angled with respect to the target surface to facilitate deflection of the blade such that at least half of the blade is in contact with the target surface, and wherein the first and second elongated surfaces are angled relative to the grip portion of the handle such that when the handle is gripped to orient the second elongated surface towards the target surface the second elongated surface is angled with respect to the target surface to facilitate removal of the unwanted particles from the target surface by aligning the plurality of bristles substantially perpendicular to the target surface.

11. A method in accordance with claim 10, wherein the neck portion is curvilinear such that when the grip portion is parallel with the target surface and the first elongated surface of the head is oriented towards the target surface, an apex of the neck portion is positioned closer to the target surface than is the grip portion.

12. A method in accordance with claim 1, wherein the blade is constructed of polyurethane.

13. A method in accordance with claim 12, wherein the polyurethane has a Shore hardness of between 46 and 54 on the Shore A durometer scale.

14. A method in accordance with claim 12, wherein the polyurethane is between 80 and 90 percent polyester resin, between 0.5 and 2 percent trimethylolpropane, between 0.5 and 2.5 percent butanediol, between 1.5 and 3.5 percent 4,4′-Methylenebis(2-chloroaniline), and between 8 and 10 percent dioctyl phthalate.

15. A method in accordance with claim 1, wherein the blade has a thickness of between two millimeters and four millimeters, inclusive.

16. A method in accordance with claim 15, wherein the blade has a thickness of between 3.2 millimeters and 3.6 millimeters, inclusive.

17. A method in accordance with claim 1, wherein the target surface includes one or more of a knitted natural fiber, a fleece, a clothing fabric, a carpet, an upholstery material, or a vehicle interior.

18. A method in accordance with claim 1, wherein the unwanted particles includes at least one or more of fabric pills, hair, dander, lint, plant material, or animal fur.
